(19) United States
(12) Patent Application Publication
(10) Pub. No.: US 2009/0256295 A1
(43) Pub. Date: Oct. 15, 2009

(54) BRUSHLESS MOTOR

(76) Inventor: Yuji KODAMA, Ueda-shi (JP)

Correspondence Address: BIRCH STEWART KOLASCH & BIRCH, PO BOX 747, FALLS CHURCH, VA, 22040-0747, US

(21) Appl. No.: 12/402,718

(22) Filed: Mar. 12, 2009

(30) Foreign Application Priority Data
Apr. 10, 2008 (JP) 2008-102013

(51) Int. Cl. F16F 7/00

(52) U.S. Cl. 267/141

(57) ABSTRACT

A brushless motor includes a rotor; a motor shaft supporting the rotor; a bearing section radially supporting the motor shaft; a thrust receiving section receiving an end of the motor shaft in the thrust direction; and an elastic damper ring being fitted on the motor shaft, the elastic damper ring being located between a circular groove, which is formed in the vicinity of the end of the motor shaft received by the thrust receiving section, and an end face of the bearing section.

### CROSS-REFERENCE TO RELATED APPLICATION

This application is based upon and claims the benefit of priority of prior Japanese Patent Application No. 2008-102013, filed on Apr. 10, 2008, the entire contents of which are incorporated herein by reference.

### FIELD

The embodiment discussed herein is related to a brushless motor used in an office automation equipment, e.g., printer, copier, DVD drive unit, an in-car equipment, e.g., sheet air conditioner, cooling blower, a projector, etc.

### BACKGROUND

A conventional outer rotor-type DC brushless motor will be explained. A cylindrical housing is attached to a motor case, a bearing section is attached to an inner part of the housing, and a motor circuit board and a stator core are attached to an outer part thereof. A rotor having a magnet is integrally attached to a motor shaft, and the motor shaft is inserted into the housing and rotatably supported by the bearing section. The housing is integrally attached to the motor case.

As shown in FIG. 4, a retainer washer 56 having a split 56a is fitted in a circular groove formed in an end part 52 of the motor shaft 51, which supports the rotor, as a retaining structure. Adjust washers 58 and 59 are fitted between an end face 57a of the bearing section, which radially supports the motor shaft 51, and the retainer washer 56 so as to adjust play in the thrust direction. Note that, if an enough space exists, a metallic snap ring can be employed instead of the retainer washer 56.

Japanese Laid-open Patent Publication No. H09-182356 discloses a bearing structure of a motor, which acts as a structure for retaining a motor shaft and which is capable of receiving a thrust load as a thrust bearing. Further, Japanese Laid-open Patent Publication No. 2003-164100 discloses a structure for retaining a rotor shaft, in which a shaft end is biased in the thrust direction so as to press a contact part attached to a motor shaft onto a bearing. By the structure, assembling efficiency and sealing property can be improved.

Note that, in case of highly reducing noises of the motor, a sliding structure, in which a member slides on a thrust receiving member provided to a bearing or an end part of the bearing, is avoided. Further, the end part 52 of the motor shaft 51 is rounded as shown in FIG. 4 or steel balls (not shown in FIG. 4) are press-fitted to the end part 52, and a thrust receiving member 53 is accommodated in a concave part 55 of a thrust cover 54 so as to support the end part 52 and receive the thrust load. With this structure, the retaining structure and the structure of receiving the thrust load are separated.

In case of the outer rotor-type motor in which the retaining structure and the thrust receiving structure are separated, the rotor is fixed at a position close to the end part of the motor shaft by magnetic forces of the magnet and the stator core. Therefore, when the motor is vibrated or impacted by external forces, the rotor is instantaneously bounded in the axial direction, within a range of the play, by inertia, and then returned. With this action, in FIG. 4, noises are generated between the adjust washer 59 and an end face 57a of the bearing and between the end part 52 of the motor shaft 51 and the thrust receiving member 53. The noise generated between the end part 52 of the motor shaft 51 and the thrust receiving member 53 can be reduced by elasticity of the thrust receiving member 53 and a configuration of the thrust cover 54. However, the noise generated between the adjust washer 59 and an end face 57a of the bearing cannot be reduced.

In the retaining structure shown in FIG. 4 and the retaining structures disclosed in the Japanese Patent Gazettes, the washer having the split, the metallic snap ring and a resin-molded member having a slit are used as the retaining members, so there are problems of increasing production costs of parts and complexifying die assemblies. On the other hand, if no split or slit is formed, the retaining member cannot be tightly fitted in the circular groove and the sufficient retaining structure cannot be produced.

### SUMMARY

Accordingly, it is an object in an aspect of the embodiment to provide a brushless motor, which has a simple structure for retaining a motor shaft in the thrust direction and which is capable of reducing noises generated between a bounded rotor and a bearing section.

According to an aspect of the embodiment, a brushless motor includes a rotor; a motor shaft supporting the rotor; a bearing section radially supporting the motor shaft; a thrust receiving section receiving an end of the motor shaft in the thrust direction; and an elastic damper ring being fitted on the motor shaft, the elastic damper ring being located between a circular groove, which is formed in the vicinity of the end of the motor shaft received by the thrust receiving section, and an end face of the bearing section.

The damper ring has enough elasticity, so that the damper ring can be sufficiently engaged with the circular groove without forming a split or a slit.

Preferably, the damper ring is composed of an elastic resin material, and a small ring section, which is fitted in the circular groove of the motor shaft, and a large ring section, which is fitted on the motor shaft and faces the end face of the bearing section, are integrally formed in the damper ring.

Preferably, the damper ring is fitted on the motor shaft with an adjust washer, which is provided between the damper ring and the end face of the bearing section.

Preferably, the damper ring is provided between a retaining washer or a metallic snap ring, which is fitted in the circular groove, and the end face of the bearing section.

If the damper ring is insufficiently engaged with the circular groove of the motor shaft or a thrust load is great, the damper ring may have only the large ring section, without forming the small ring section, and may be cooperated with the retaining washer or the metallic snap ring, which is fitted in the circular groove.

Further, preferably, the damper ring is composed of thermoplastic elastomer.

In the brushless motor of the present invention, the elastic damper ring is fitted on the motor shaft and located between the circular groove, which is formed in the vicinity of the end of the motor shaft received by the thrust receiving section, and the end face of the bearing section. With this structure, even if the rotor is bounded in the thrust direction, noises generated by colliding with the end face of the bearing section can be reduced by the damper ring. Further, the damper ring acts as a retaining member fitting in the circular groove of the motor shaft, so that number of parts can be reduced and production cost can be also reduced.

In case that the damper ring is composed of the elastic resin material and the small ring section, which is fitted in the circular groove of the motor shaft, and the large ring section, which is fitted on the motor shaft and faces the end face of the bearing section, are integrally formed in the damper ring, the damper ring has enough crashworthy and weather resistance. By integrally forming the small ring section and the large ring section, the damper rings can be inexpensively mass-produced.

In case that the damper ring is fitted on the motor shaft with the adjust washer, which is provided between the damper ring and the end face of the bearing section, the play of the motor shaft in the thrust direction can be highly reduced so that noises generated by colliding the adjust washer with the end face of the bearing section can be reduced.

In case that the damper ring is provided between the retaining washer, which is fitted in the circular groove, and the end face of the bearing section, the shape of the damper ring can be simplified.

In case that, the damper ring is composed of thermoplastic elastomer, the elastomer has elasticity of rubber and moldability of plastic so that the damper ring can have enough crashworthy and can be suitably mass-produced.

### BRIEF DESCRIPTION OF THE DRAWINGS

Embodiments of the present invention will now be described by way of examples and with reference to the accompanying drawings, in which:

FIG. 1 is a sectional view of an outer rotor-type brushless motor;

FIG. 2 is an enlarged partial sectional view of a part A of FIG. 1, wherein a thrust receiving section receiving a motor shaft is shown;

FIG. 3A is a plan view of a damper ring;

FIG. 3B is a sectional view of the damper ring; and

FIG. 4 is a enlarged partial sectional view of the conventional outer rotor-type brushless motor, wherein the thrust receiving section receiving the motor shaft is shown.

### DESCRIPTION OF THE EMBODIMENT

A preferred embodiment of the present invention will now be described in detail with reference to the accompanying drawings. In the following description, a blower motor (an outer rotor-type DC brushless motor) will be explained as an example.

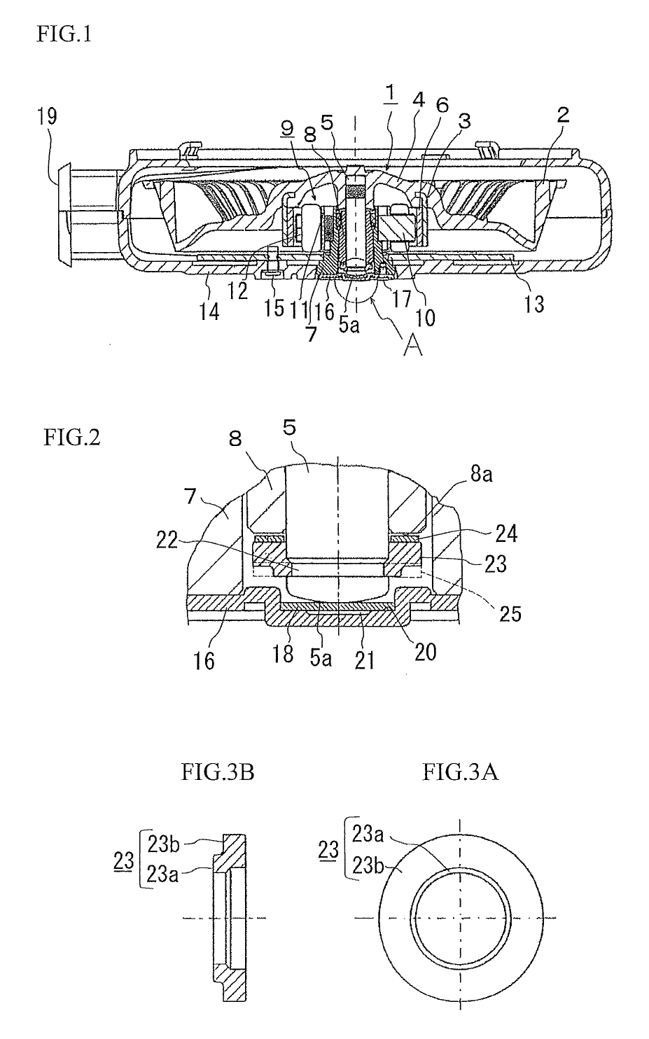

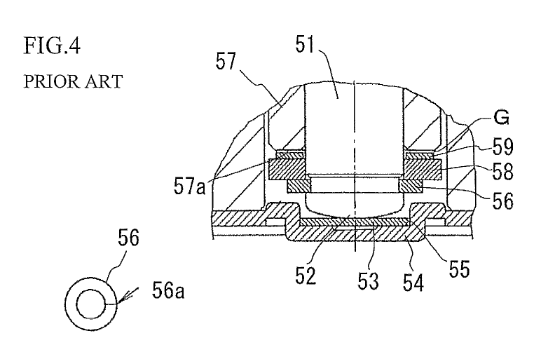

An outline of the blower motor will be explained with reference to FIG. 1.

In a rotor shown in FIG. 1, impellers 2 and a cylindrical rotor yoke 3 are integrally formed by insert molding. One end of a motor shaft 5 is integrated with a hub 4 of the impellers 2. A ring-shaped magnet 6 is fixed on an inner circumferential face of the rotor yoke 3. In the magnet 6, N-poles and S-poles are alternately formed in the circumferential direction. The motor shaft 5 is supported, by a bearing section 8 inserted in a bearing housing 7, in the radial direction and the thrust direction.

In a stator 9, a stator core 10 is attached outside of the cylindrical bearing housing 7, which is composed of a metal. The stator core 10 is covered with an insulator 11, and motor coils 12 are respectively wounded on tooth sections (pole teeth). A motor circuit board 13, in which a motor driving circuit is formed, is also fixed to the bearing housing 7 and included in an assembly together with the stator 9. The assembly is fixed to a motor case 14 by screws 15. A thrust cover 16 is fixed to the bearing housing 7 by screws 17. A bearing section 8, e.g., oil-impregnated bearing, ball bearing, which radially supports the motor shaft 5, is provided in the bearing housing 7.

In FIG. 1, pole centers of the magnet 6 of the rotor 1 are shifted with respect to centers of the tooth sections of the stator core 10, and the end part 5a of the motor shaft 5 is always drawn, in the axial direction, toward a thrust receiving section 18, which is fitted in the thrust cover 16 (see FIG. 2). When the rotor 1 is rotated, the impellers 2 are simultaneously rotated. So, outside air is axially sucked toward the impellers 2, circulated in the motor case 14 and then discharged from an outlet 19.

FIG. 2 is an enlarged partial sectional view of a part A of FIG. 1. In FIG. 2, the thrust cover 16 composed of a metal is pressed to form a concave section 20. The thrust receiving section 18 is fitted to an inner bottom part of the concave section 20 and supports the end part 5a of the motor shaft 5 in the thrust direction. The thrust receiving section 18 is composed of a low friction resin material having enough abrasion resistance, e.g., polyether ether ketone (PEEK). The thrust receiving section 18 is provided to the inner bottom part of the concave section 20, and the rounded end part 5a of the motor shaft 5 point-contacts the thrust receiving section 18. Another concave section 21 is formed at a prescribed position in the concave section 20 of the thrust cover 16, at which the axial line of the motor shaft 5 downwardly extended from the contact point of the thrust receiving section 18 and the end part 5a of the motor shaft 5 crosses the bottom face of the concave section 20.

Next, a structure for retaining the motor shaft 5 will be explained. A circular groove 22 is formed in an outer circumferential face of the motor shaft and located close to the end part 5a thereof. An elastic damper ring 23 is fitted between the circular groove 22 and the end face 8a of the bearing section 8. Preferably, the damper ring is composed of thermoplastic elastomer, e.g., Hytrel (registered trademark), which has elasticity of rubber and moldability of plastic. An adjust washer 24 is provided between the damper ring 23 and the end face 8a of the bearing section 8 so as to absorb play in the thrust direction. By using the adjust washer 24, the play of the motor shaft 5 in the thrust direction can be reduced, and collision noises generated between the adjust washer 24 and the end face 8a of the bearing section 8 can be reduced. If the play can be suitably reduced by the damper ring 23, the adjust washer 24 can be omitted.

Even if the rotor 1 is bounded in the thrust direction, the collision noises generated between the adjust washer 24 and the end face 8a of the bearing section 8 can be reduced. Further, the damper ring 22 suitably engages with the circular groove 22 of the motor shaft 5 and acts as a retaining member, so that number of parts of the brushless motor can be reduced and production cost of the brushless motor can be reduced.

In FIGS. 3A and 3B, the damper ring 23 has a small ring section 23a, which is fitted in the circular groove 22 of the motor shaft 5, and a large ring section 23b, which is fitted on the motor shaft 5 and faces the end face 8a of the bearing section 8, and they are composed of the thermoplastic elastomer and integrally formed. Therefore, the damper ring 23 has elasticity of rubber and can be molded by injection molding, so the damper rings 23 can be suitably mass-produced.

In FIG. 2, when the brushless motor is vibrated or impacted by external forces, the rotor 1 (see FIG. 1) is instantaneously bounded, the adjust washer 24 collides with the end face 8a of the bearing section 8, and then the end part 5a of the motor shaft 5 is drawn and collides with the thrust receiving section 18. Impactive forces, which are generated by the collisions and applied to the adjust washer 24 and the end face 8a of the bearing section 8, can be absorbed by the damper ring 23. Further, impacts generated by point collisions of the center part of the end part 5a, in which surface pressure is high, are dispersed by slightly bending the thrust receiving section 18 toward the concave section 21 immediately thereunder. Therefore, the collision noises can be reduced. With this effect, commercial value of the brushless motor can be improved, especially as in-car products to which vibration and impactive forces are applied.

In case that a depth of the circular groove 22 is insufficient due to a diameter of the motor shaft 5 or that external impactive forces are great, a retaining washer or a metallic snap ring 25 (see FIG. 2) may be provided to the circular groove 22 of the motor shaft 5. In this case, a shape of the damper ring 23 can be simplified and fitted between the retaining washer or the metallic snap ring 25, which has been fitted in the circular groove 22 located close to the end part of the motor shaft, and the adjust washer 24.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiment of the present inventions has been describe in detail, it should be understood that the various changes, substitution, and alterations could be made hereto without departing from the spirit and scope of the invention.

What is claimed is:

1. A brushless motor,
comprising:
a rotor;
a motor shaft supporting the rotor;
a bearing section radially supporting the motor shaft;
a thrust receiving section receiving an end of the motor shaft in the thrust direction; and
an elastic damper ring being fitted on the motor shaft, the elastic damper ring being located between a circular groove, which is formed in the vicinity of the end of the motor shaft received by the thrust receiving section, and an end face of the bearing section.

2. The brushless motor according to claim 1,
wherein the damper ring is composed of an elastic resin material, and
a small ring section, which is fitted in the circular groove of the motor shaft, and a large ring section, which is fitted on the motor shaft and faces the end face of the bearing section, are integrally formed in the damper ring.

3. The brushless motor according to claim 1,
wherein the damper ring is fitted on the motor shaft with an adjust washer, which is provided between the damper ring and the end face of the bearing section.

4. The brushless motor according to claim 1,
wherein the damper ring is provided between a retaining washer or a metallic snap ring, which is fitted in the circular groove, and the end face of the bearing section.

5. The brushless motor according to claim 1,
wherein the damper ring is composed of thermoplastic elastomer.
